(19) United States
(12) Patent Application Publication
(10) Pub. No.: US 2011/0071916 A1
(43) Pub. Date: Mar. 24, 2011

(54) VIRTUAL RELEASE PARTY

(76) Inventor: John Grooms, Cincinnati, OH (US)

(21) Appl. No.: 12/941,989

(22) Filed: Dec. 7, 2010

Related U.S. Application Data
(63) Continuation-in-part of application No. 10/831,392, filed on Apr. 23, 2004, now abandoned.

(51) Int. Cl. G06Q 30/00

(52) U.S. Cl. 705/26.1

(57) ABSTRACT

A method, apparatus and program product provide a mechanism for distributing recorded content whereby content is sold through a limited channel known as a virtual release party, and a user receives a commission for referring a purchaser to a website that sells the content. The user submits an identifier associated with the referring entity to the website when purchasing the content. The referring entity is thus credited automatically with the purchase of the content.

### CROSS-REFERENCE TO RELATED APPLICATION

This application is a continuation-in-part of U.S. patent application Ser. No. 10/831,392, filed May 23, 2004 by John Grooms, the inventor herein, which application is hereby incorporated by reference in its entirety.

### FIELD OF THE INVENTION

The present invention relates generally to computer operations and applications, and more particularly, to the programmatic management of Internet related sales of downloadable music and video content to maximize consumption via communications between computers.

### BACKGROUND OF THE INVENTION

Consumer demand for recorded music has had a record nine year sales decline (2001-2010) driven by three factors: 1) overall decline in consumption of compact discs, 2) inability of digital music sales to offset compact disc decline because digital music consumption skews heavily toward individual songs (with individual songs generating 1/10 to 1/20 of prototypical album revenue), 3) simplicity and ease of access to digital sites which offer free music consumption both legally (e.g. Pandora) and illegally.

The difficulties facing the recording industry are further exacerbated by archaic practices and collapsed infrastructures formerly used for commercialization of recorded content. The traditional method of promoting new music is twofold: 1) Record release parties to “celebrate” completion of a project by leveraging industry insiders, producers, media and trade representatives to create initial buzz and 2) Radio airplay to “market” new music to listeners, initiating a purchase cycle of awareness (I heard “Rock & Roll All Nite”), trial (I just bought the “Love Gun” album), repeat consumption (I now own 26 KISS albums) and loyalty.

Unfortunately, record release parties no longer create significant buzz because in the new digital landscape, music awareness is driven by digital marketing techniques such as search marketing and content matching, rather than through personal relationships, i.e., ‘knowing the right people”. Also, radio airplay creates less of a marketing footprint because the proliferation of internet and satellite stations translates to more consumer choices and inversely affects the overall reach of individual stations, diminishing awareness, trial, repeat and loyalty.

These conditions create a significant dilemma for large record companies and independent artists alike. The challenge they both face is how to mitigate risk involved with creating and commercializing new music, by reaching target consumers in a repeatable and affordable way that offers predictability regarding consumption patterns.

Consequently, and for in part the above delineated reasons, there exists a need for an improved manner for managing the commercialization and distribution of recorded content.

### SUMMARY OF THE INVENTION

The present invention provides an improved apparatus, method and program product for managing the distribution of recorded data content in a web-based environment. A server at the center of the apparatus and method, hosts a “virtual record release party” within which a user may a establish a general release date for new digital content, such as a new song/album, contingent upon a condition of attendance at the virtual record release party, such as a condition on the total number of purchases via the server, after which the content will be release to be accessed en masse via download on the diverse channels presently available.

This apparatus, method and program product affords several benefits: 1) Digital content (new song/album) is not released until a specific number of sales are achieved thereby locking specific sales revenue targets, 2) New song snippets and album teaser tracks are leaked & shared in a controlled fashion building tension and excitement as the release date approaches, 3) The new song/album or other digital content is only released to the public domain en masse and exposed to potential piracy after achieving the specified sales threshold thus limiting the negative impact of piracy on new song/album releases.

In one aspect, the invention features a commission structure in which consumers who purchase the new digital content (e.g., song/album) are encouraged to help drive additional pre-purchases and reach the sales threshold, through the payment to consumers of a commission or referral fee, during the period that the new digital content is approaching its release date.

To this end, the record company or independent artist submits a record release date and sales threshold target to the website which sources this information to search engines and wikis. As consumers visit the site they are invited to pre-purchase the new song/album which will be available for download on the record release date.

In the disclosed particular embodiment, consumers who pre-purchase the song/album receive a unique identifier which registers them as a referring entity, as set forth in the above-referenced U.S. patent application which is incorporated herein by reference.

Consumers registered as referring entities may also receive unique collateral materials (song snippets, teaser tracks, album art, stories, etc.) to share and encourage additional consumption.

Recipients of collateral material (family/friends/virtual acquaintances) may then visit the server/website as new consumers and enter the unique identifier of the previous consumer who referred them. Upon entering the site, if a new consumer opts to purchase the song/album via pre-payment, the previous consumer receives a monetary credit (sales commission) as a referring entity.

Entrance to and usage of the website always requires a unique identifier from a referring entity. Thus, from the onset of the record release to the conclusion (launch date and specified sales threshold met) all users are prompted to submit a password and/or token comprising the identifier at their local computer. Users may further be prompted for financial information, such as credit card data and a billing address.

Content may be downloaded or mailed to users on the record release date once the sales threshold has been achieved. Similarly, sales commissions may be credited or mailed to users on the record release date.

New song/album sales thus become driven by personal referrals, and are no longer dependent on radio airplay. Referral based compensation works to mitigate piracy by limiting exposure of a new song/album until a critical sales threshold is achieved, as well as, offering a financial incentive for purchase referrals mitigating desire to illegally duplicate and distribute copyrighted material.

By virtue of the foregoing there is thus provided an improved design file analysis mechanism that addresses shortcomings of conventional techniques. These and other objects and advantages of the present invention shall be made apparent in the accompanying drawings and the description thereof.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiment given below, serve to explain the principles of the invention.

FIG. 1 is a block diagram of a client-server computer system having software consistent with the invention.

FIG. 2 is a flowchart having a sequence of steps executable by the client and server computers of the system of FIG. 1 for establishing a user account.

FIG. 3 is a flowchart having a sequence of steps executable by the client and server computers of the system of FIG. 1 for crediting a referring entity with a content purchase.

FIG. 4 is a flowchart having a sequence of steps executable by the client and server computers of the system of FIG. 1 for establishing a distribution website.

FIG. 5 shown an exemplary computer interface screen configured to display and prompt information indicative of a user account.

### DETAILED DESCRIPTION OF DRAWINGS

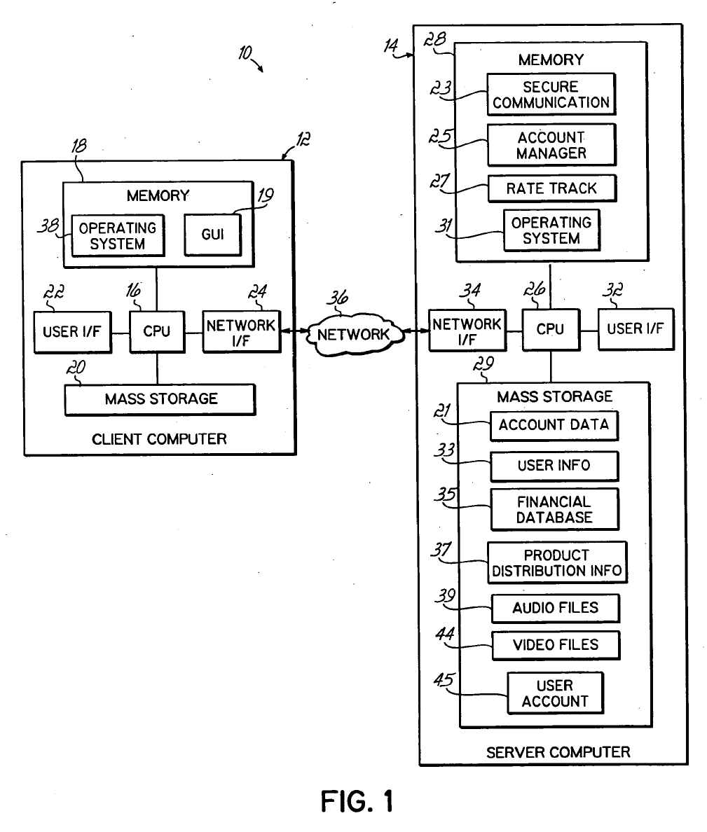

FIG. 1 illustrates a client-server based computer system 10 that is configured to manage the distribution of recordable content. More particularly, an individual using the system 10 may receive a commission for referring a purchaser to a website that sells the content. In one sense, the system 10 includes web-based referral processes that creates a virtual sales force. The virtual sales force in turn drives the web-based distribution of products through compensation for word-of-mouth type promotion and advocacy. In conjunction with the virtual release party model for promoting the sales events, these principles lead to a uniquely effective sales technique for digital content.

For instance, consumers may visit a website hosted by a server 14 configured to facilitate the distribution of content. The consumers are allowed to join the site as a virtual salesman after viewing and/or purchasing content. Exemplary content may include recordable media for conveying the content, such as compact discs (CD's), tapes, digital versatile discs (DVD's), as well as downloadable electronic files. As such, purchases may include the delivery of physical discs, as well as the download of electronically transferrable digital content.

Upon deciding to join the virtual sales force, the user creates a password, token or other identifier to be used by future consumers referred to the site. If the newly referred consumers purchase products and enter the respective identifier, the person or entity associated with the identifier is compensated for the promotion and sales closed. Such compensation for referrals may be realized in the form of cash credit paid directly to consumer credit cards or cash credits made to a deposit account associated with the website and maintained by the server computer 14.

Turning more particularly to FIG. 1, the system 10 includes at least one apparatus, e.g., one or more client computers 12 and one or more server computers 14. For the purposes of the invention, each computer 12, 14 may represent practically any type of computer, computer system or other programmable electronic device capable of functioning as a client and/or server in a client-server environment. Moreover, each computer 12, 14 may be implemented using one or more networked computers, e.g., in a cluster or other distributed computing system. As is common in many client-server systems, multiple client computers 12 will typically be interfaced with a given server computer 14. While more capable computer systems may present advantages, a suitable server 14 for purposes of this specification may comprise any device configured to receive and process an electronic message transmitted from the client computer 12.

Client computer 12 typically includes a central processing unit 16 comprising at least one microprocessor coupled to a memory 18, which may represent the random access memory (RAM) devices comprising the main storage of computer 12, as well as any supplemental levels of memory, e.g., cache memories, non-volatile or backup memories (e.g., programmable or flash memories), read-only memories, etc. For instance, the memory 18 may store a graphic user interface (GUI) program 19 to display information to the user on the monitor of the client computer 12. As discussed herein, the GUI program 19 may at one instance present terms and conditions related to web-based content distribution downloaded from the server using the browser function of a network interface 24.

In addition, memory 18 may be considered to include memory storage physically located elsewhere in computer 12, e.g., any cache memory in a processor in CPU 16, as well as any storage capacity used as a virtual memory, e.g., as stored on a mass storage device 20 or on another computer coupled to computer 12.

Computer 12 also typically receives a number of inputs and outputs for communicating information externally. For interface with a user or operator, computer 12 typically includes a user interface 22 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 12 may also include one or more mass storage devices 20, e.g., a floppy or other removable disc drive, a hard disc drive, a direct access storage device (DASD), an optical drive (e.g., a CD drive, a DVD drive, etc.), and/or a tape drive, among others.

Computer 12 includes the interface 24 with one or more networks (e.g., a LAN, a WAN, a wireless network, and/or the Internet, among others) to permit the communication of information with other computers and electronic devices. It should be appreciated that computer 12 typically includes suitable analog and/or digital interfaces between CPU 16 and each of components 18, 20, 22 and 24 as is well known in the art.

Similar to computer 12, computer 14 includes a CPU 26, memory 28, mass storage 29, user interface 32 and network interface 34. However, given the nature of computers 12 and 14 as client and server, in many instances computer 14 will be implemented using a multi-user computer such as a server computer, a midrange computer, a mainframe, etc., while computer 12 will be implemented using a desktop or other single-user computer. As a result, the specifications of the CPU's, memories, mass storage, user interfaces and network interfaces will typically vary between computers 12 and 14. However, one skilled in the art will appreciate that other hardware environments are contemplated within the context of the invention.

As with the client computer 12, the memory 28 of the server computer 14 includes stored information useful in managing web-based distribution of content. For instance, the computer 12 may include a secure communication program 23 for protecting financial and other personal data communicated during a distribution management process. To this end, the program 23 typically includes encryption technologies. Encryption is the process of using a mathematical algorithm to transform information into a format that is hard to read. This format is called ciphertext. Decryption is a process that uses another algorithm to transform encrypted information back into a readable format, called plain text. Although shown in FIG. 1 as only being present on the server computer 14, one skilled in the art will appreciate that encryption, decryption, compression and other formatting technologies may be present at either or both the client and server computers 12 and 14, respectively.

The memory 18 shown in FIG. 1 also includes an account manager program 25 that facilitates management of users financial, personal and other computer files and accounts. Functions included within the account manager 25 may include credit card processing and bank account features, along with a secure electronic signature program, where desired. A rate track program 27 automatically keeps track of information that relates to how much a given file is accessed, for instance.

The exemplary mass storage 29 of the server computer 14 includes account data 21, user information 33, a financial database 15, as well as product distribution and user account information 37 and 45, respectively. The mass storage 29 shown in FIG. 1 also includes audio and video files 39 and 44, which may comprise samples, downloadable files and other recordable content.

The computers 12, 14 are generally interfaced with one another via a network 36, which may be public and/or private, wired and/or wireless, local and/or wide-area, etc. Moreover, network 36 may represent multiple, interconnected networks. In the illustrated embodiment, for example, network 36 includes the Internet.

Each computer 12, 14 operates under the control of an operating system 38, 40 and executes or otherwise relies upon various computer software applications, components, programs, objects, modules, data structures, etc. Moreover, various applications, components, programs, objects, modules, etc. may also execute on one or more processors in another computer coupled to computer 12, 14 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention.

While the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable discs, hard disc drives, magnetic tape, optical discs (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the environment illustrated in FIG. 1 is not intended to limit the present invention. Indeed, those skilled in the art will recognize that other alternative hardware and/or software environments may be used without departing from the scope of the invention. For exemplary purposes, however, much of the remaining portion of this specification addresses program flows suitable for execution by and within the context of the hardware and software environment of FIG. 1.

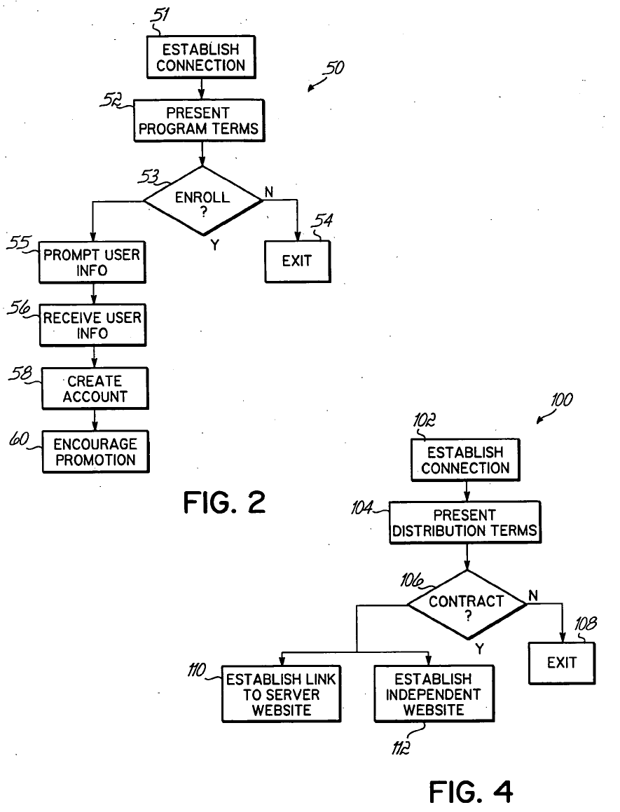

The flowchart 50 of FIG. 2 shows a series of exemplary process steps executable by the server computer 14 of the system 10 of FIG. 1 that are configured to establish a user account. More particularly at block 51 of the FIG. 2, a client initially establishes a connection to the server computer 14 using their local computer 12. The steps of FIG. 2 thus presuppose that the user/client does not have an account prior to establishing the connection. Generally at block 51, a browser application of their client computer 12 will link to a Uniform Resource Location (URL) associated with a website hosted by the server computer 14. A URL is a term for a generic Internet location identifier. That is, a URL identifies an address within a distributed network system.

Once the connection to the server website is established at block 51, the operating system 31 of the server computer 14 may present the user with information indicative of the web-based content distribution program. For example, the server computer 14 may cause a GUI to be displayed on the monitor of the client computer 12. The GUI may include terms and conditions related to web-based content distribution. For instance, such terms may include license, stipulations and agreements. The server computer 14 (and GUI) may prompt the user to decide whether they wish to enroll in the program at block 53. Where a user indicates that they are not interested in enrolling in the web-based distribution system at block 53, the session may end at block 54. Where the server computer 14 alternatively receives confirmation that a user wishes to proceed with enrollment in the program, the operating system 31 may prompt user information at block 55 of FIG. 2. Exemplary user information prompted at block 55 and received at block 56 may include name, postal/electronic mail address and other contact information. Other user information received at block 56 may include an identifier. The identifier may be used to identify the user as a source of a referral. As such, an identifier may include a password and/or a token associated with the user. In one embodiment, an identifier may comprise a web-supported link that points to identifying information. For instance, a user may select a displayed link or name from a list of referring entities. A user for the purpose of this specification may include a single or group or persons, e.g., a college student or a corporate entity. The personal information may be retained in a database within memory 29 accessible to the server computer 14.

After receiving information required for establishing an account at block 56, the operating system 31 may cause the account 45 to be created at block 58 of FIG. 2. Where so configured, the server computer 14 may present the new account member with suggestions and tips for encouraging promotion and distribution of the content at block 60.

For example, a user may be encouraged to promote music using whatever means and marketing techniques they are capable of to drive traffic back to the established website. Methods of promoting and referring may include posters, flyers, pluggers embedded within a website and/or an identifier and print advertisements. Another effective form of referring potential customers to a website may include casually telling someone about the content in a passing conversation, in an electronic chat room, over the radio or at a family or friendly gathering. Such methods can be relatively inexpensive or even free and are often most effective in swaying the opinion of potential purchasers. Embodiments consistent with the present invention thus circumvent existing payola laws for even greater returns.

In one example, a college student may tell members of their fraternity about the content and website. A high school student may hype and promote a video available through the website by using Internet chat rooms. A disc jockey may talk about the music on air and direct listeners to the website. Such promotion techniques are largely untapped in a commercial sense, yet are potentially more global and effective than conventional infrastructure mechanisms. In a more extreme example, a bootlegger may decide that there is a better rate of return promoting the website versus duplicating and selling music illegally.

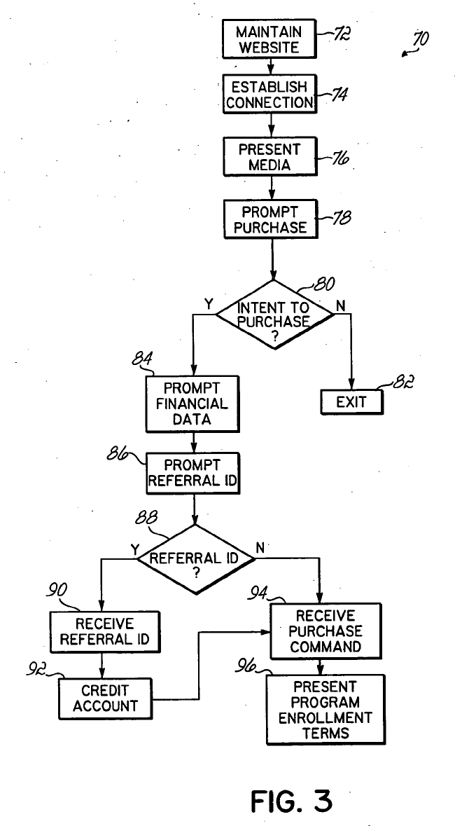

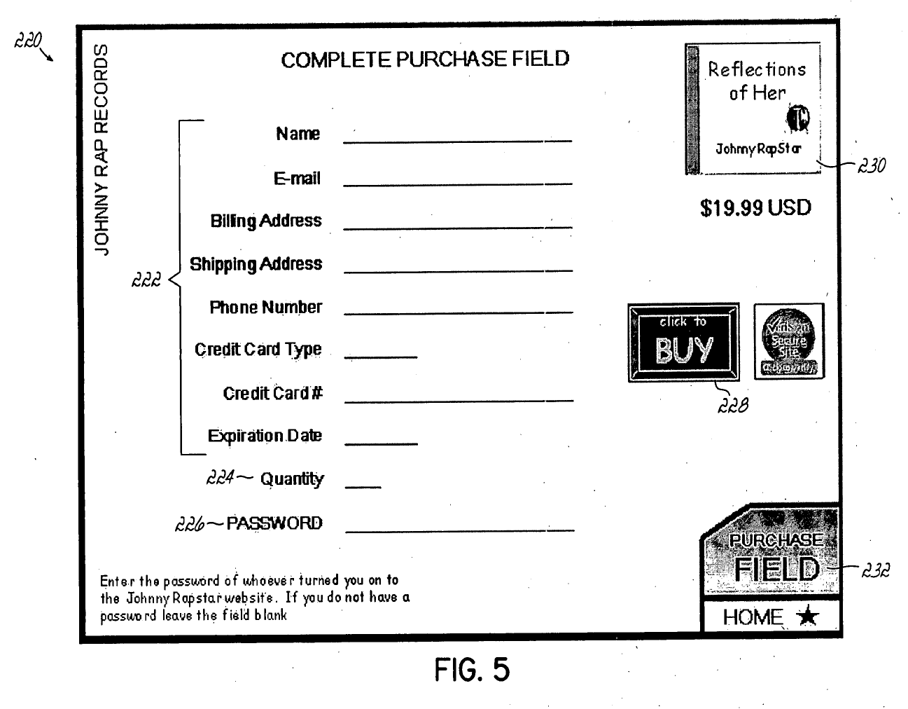

FIG. 3 is a flowchart 100 having a sequence of steps executable by the client and server computers 12 and 14, respectively, of the system of FIG. 1 for crediting a referring entity with a content purchase. More particularly, the server computer 14 of FIG. 1 maintains a distribution website at block 72 of FIG. 3. Maintenance of the website may include updating data displayed within the website. A connection is established to block 74 between the client computer 12 and the server computer 14. Where desired, the connection may be protected using a secure connection or other encryption technologies.

Where so configured at block 76 of FIG. 3, the server computer may initiate presentation of content at block 76. Such content may be presented in response to a specific request from a potential purchaser. For instance, a user logging in to the website may wish to hear a sample from a song or compact disc they are contemplating purchasing. The operating system 31 of the server computer 14 may alternatively or additionally present selected content based on song/video popularity. Such popularity may be established by tracking downloads, for instance. Other information presented at block 76 of FIG. 3 may include a display of song lyrics, and/or a listing of related merchandise. Exemplary related products may include hats, t-shirts, backpacks, as well as magnets, posters, stickers and other merchandise.

The server computer 14 may prompt the purchase of content at block 78. Such prompting at block 78 may include the display of a GUI containing terms of purchase, such as cost information. Where the server computer 14 receives indication that the user does not intend to purchase content at block 80, the session may end at block 82.

Where the user alternatively wishes to purchase content at block 80, the server computer 14 may prompt purchaser information. Exemplary purchaser information may include name, credit card, mailing address, IP/URL address, duration of visit and an identifier associated with the referring entity. More particularly, the server computer 14 may prompt financial data from the user at block 84. Such financial data may include a credit card number and requisite contact information, for instance.

The server computer 14 may additionally prompt the user to enter an identifier at block 86. The identifier is associated with an entity that may have referred the purchaser to the website. Where such a referral identifier is within the possession of the purchaser at block 88, the server computer may receive and process the identifier at block 90. The applicable account 45 of the referring entity is credited at block 92. In one embodiment, the account 45 is credited concurrently with the server computer 14 receiving a purchase command at block 94. Where no referral identifier is available at block 88, the user may still purchase the content at block 94.

Where desired, the server computer 14 may present the user with program enrollment terms at block 96. Thus, the purchaser may elect to, themselves, become a referring entity as discussed in connection with FIG. 2.

FIG. 4 is a flowchart having a sequence of steps executable by the client and server computers of the system of FIG. 1 for establishing a distribution website. More particularly, the flowchart 100 of FIG. 4 shows how an artist or record company may establish a distribution website that is consistent with the principles of the present invention. An interested artist or record company establishes a connection from their local computer 12 to the server computer 14 at block 102. A GUI displayed locally on the client computer 12 may present distribution terms at block 104 of FIG. 4. Such terms may include licensing agreements, for instance.

Where the artist or record company wishes to contract at block 106 of FIG. 4, the server computer 14 facilitates establishing a website associated with the contracted artist or record company. As noted in FIG. 4, such facilitation may include establishing a URL link to an existing server website at block 110. Such may be the case where an artist does not wish to maintain their own website, or a record company, for instance, wishes to share in the popularity of an established website. As such, a potential seller is not required to establish and maintain their own website. They merely need to establish an account and an identifier to drive traffic and close sales. An artist or record company may alternatively establish their own independent website at block 112. The independent website may include licensed trademark and URL link information associated with a host of the server computer 14. For instance, such information may pertain to licensing fees for re-application on websites other than that hosted by the server computer 14.

While the present invention has been illustrated by a description of various embodiments, and while these embodiments have been described in considerable detail, it is not the intention of the applicants to restrict or in any way limit the scope of the appended claims to such detail. For instance, while the exemplary sequence of steps shown in FIGS. 2-4 may have particular utility in certain contexts, it should be understood that the order and content of such steps may be rearranged, omitted, augmented or otherwise modified to suit alternative embodiments and application requirements. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of the applicants' general inventive concept.

What is claimed is:

1. A computer-implemented method of distributing content upon the announcement of a virtual release party, comprising:
storing the digital content and a threshold sales criterion for that digital content, and accounts for sales generating entities,
delivering the content from the server to purchasers, while accumulating sales information for that digital content for comparison to the threshold criterion,
upon the purchase of said content, obtaining from a local computer an identifier associated with a sales generating entity other than the user of the local computer,
automatically crediting the entity with a purchase of the content, and
only upon achievement of said threshold criterion, delivering the content to purchasers via sources other than the server.

2. The computer-implemented method of claim 1, wherein obtaining the identifier associated with the entity further includes submitting at least one of a password or a token associated with the entity.

3. The computer-implemented method of claim 1, wherein obtaining the identifier associated with the entity further includes selecting a link associated with the entity.

4. The computer-implemented method of claim 1, wherein obtaining the identifier associated with the entity further includes prompting the user for the identifier.

5. The computer-implemented method of claim 1, further comprising distributing the content in response to the purchase.

6. The computer-implemented method of claim 5, wherein the distributing includes at least one of downloading and postal delivery.

7. The computer-implemented method of claim 1, further comprising creating an account associated with the entity.

8. The computer-implemented method of claim 1, further comprising creating an account associated with the user as an enrolled entity.

9. The computer-implemented method of claim 1, wherein connecting to the server computer from the local computer further includes creating a website.

10. The computer-implemented method of claim 9, wherein the website includes links to multiple websites associated with at least one of additional content and additional entities.

11. The computer-implemented method of claim 1, further comprising presenting at least a portion of the content to the user prior to the purchase.

12. An apparatus comprising:
a computer; and
program code in communication with the computer, the program code configured to store digital content and a threshold sales criterion for that digital content, and accounts for sales generating entities, and deliver content from the computer to purchasers while accumulating sales information for that digital content for comparison to the threshold criterion, obtain from a user purchasing content an identifier associated with a sales generating entity other than the user, the program code being further configured to automatically credit the entity with a purchase of the content.

13. The apparatus of claim 12, wherein the program code initiates prompting the user for the identifier.

14. The apparatus of claim 12, wherein the program code initiates distributing the content in response to the purchase.

15. The apparatus of claim 12, wherein the program code initiates creating an account associated with the entity.

16. The apparatus of claim 12, wherein the program code initiates receiving financial data from the user.

17. The apparatus of claim 12, wherein the program code initiates creating a website.

18. The apparatus of claim 12, wherein the program code initiates offering to the user non-recordable medium products relating to the content.

19. A program product, comprising:
program code in communication with the computer, the program code configured to store digital content and a threshold sales criterion for that digital content, and accounts for sales generating entities, and deliver content from the computer to purchasers while accumulating sales information for that digital content for comparison to the threshold criterion, obtain from a user purchasing content an identifier associated with a sales generating entity other than the user, the program code being further configured to automatically credit the entity with a purchase of the content; and
a signal bearing medium bearing the program code.

20. The program product of claim 19, wherein the signal bearing medium includes at least one of a recordable medium and a transmission-type medium.
